(19) United States
(12) Patent Application Publication
(10) Pub. No.: US 2008/0074289 A1
(43) Pub. Date: Mar. 27, 2008

(54) WIRELESS INTERNET-PROTOCOL-BASED TRAFFIC SIGNAL LIGHT MANAGEMENT

(75) Inventors: David D. Sauder, Chaska, MN (US); John Sabat, Merrimack, NH (US)

Correspondence Address: FOGG & POWERS LLC, 10 SOUTH FIFTH STREET, SUITE 1000, MINNEAPOLIS, MN, 55402, US

(73) Assignee: ADC Telecommunications, Inc., Eden Prairie, MN (US)

(21) Appl. No.: 11/534,042

(22) Filed: Sep. 21, 2006

(51) Int. Cl. G08G 1/08; G08B 1/08

(52) U.S. Cl. 340/909; 340/539.1

(57) ABSTRACT

A system including a master controller, a plurality of wireless nodes dispersed in a geographic area and a plurality of traffic signal lights dispersed in the geographic area. The traffic signal lights are communicatively coupled to the master controller via the plurality of wireless nodes. Each wireless node in the plurality of wireless nodes is associated with a distinct Internet protocol address and a wireless communication link provides Internet protocol based communication between the plurality of wireless nodes and the master controller. The plurality of wireless nodes receives control data packets for the communicatively coupled traffic signal lights from the master controller via the wireless communication link. The control data packets comprise the distinct Internet protocol address and operational instructions for at least one traffic signal light communicatively coupled to the wireless node and each traffic signal light is responsive to the operational instructions in the control data packets.

### BACKGROUND

The flow of vehicular traffic has been studied extensively in the last few decades and traffic control software including traffic based algorithms is implemented to control the timing of traffic signal lights that regulate the vehicular traffic.

### SUMMARY

In one embodiment, a system, comprising a plurality of wireless nodes and a plurality of traffic signal lights dispersed in the geographic area. Each wireless node in the plurality of wireless nodes is associated with a distinct Internet protocol address and the traffic signal lights are communicatively coupled to the plurality of wireless nodes. A wireless communication link provides Internet protocol based communication among the plurality of wireless nodes. Each of the plurality of wireless nodes receives control data packets for the communicatively coupled traffic signal lights from others of the plurality of wireless nodes via the wireless communication link. The control data packets include one of the distinct Internet protocol addresses and operational instructions for at least one traffic signal light communicatively coupled to the wireless node. Each traffic signal light is responsive to the operational instructions in the control data packets addressed to the distinct Internet protocol address.

In another embodiment, a method of controlling a plurality of traffic signal lights includes exchanging information among a plurality of wireless nodes and sharing control of the traffic signal lights. Each of the plurality of wireless nodes is associated with a distinct Internet protocol address and at least one of the traffic signal lights. The control of the traffic signal lights is shared among the plurality of wireless nodes based on the exchanged information and based on the Internet protocol addresses.

### DRAWINGS

FIG. 1 is a block diagram representative of a system to control a plurality of traffic signal lights in accordance with the present invention.

FIGS. 2-5 are a block diagrams representative of embodiments of systems to control a plurality of traffic signal lights in accordance with the present invention.

FIG. 6 is a block diagram representative of a system to control a plurality of traffic signal lights in accordance with the present invention.

FIG. 7 is a block diagram representative of a control data packet transmitted between a traffic signal light and a master controller.

FIG. 8 is a flow diagram of one embodiment of a method to control a plurality of traffic signal lights in accordance with the present invention.

FIG. 9 is a flow diagram of one embodiment of a method to update traffic data at a master controller in accordance with the present invention.

FIG. 10 is a flow diagram of one embodiment of a method to control a plurality of traffic signal lights in accordance with the present invention.

FIGS. 11 and 12 are a block diagrams representative of embodiments of systems to control a plurality of traffic signal lights in accordance with the present invention.

FIG. 13 is a flow diagram of one embodiment of a method to control a plurality of traffic signal lights in accordance with the present invention.

FIGS. 14A and 14B are a flow diagram of one embodiment of a method to share control of traffic signal lights in accordance with the present invention.

FIG. 15 is a flow diagram of one embodiment of a method to wirelessly transmit the data packet from at least one wireless node.

FIG. 16 is a block diagram representative of an embodiment of system to control a plurality of traffic signal lights in accordance with the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

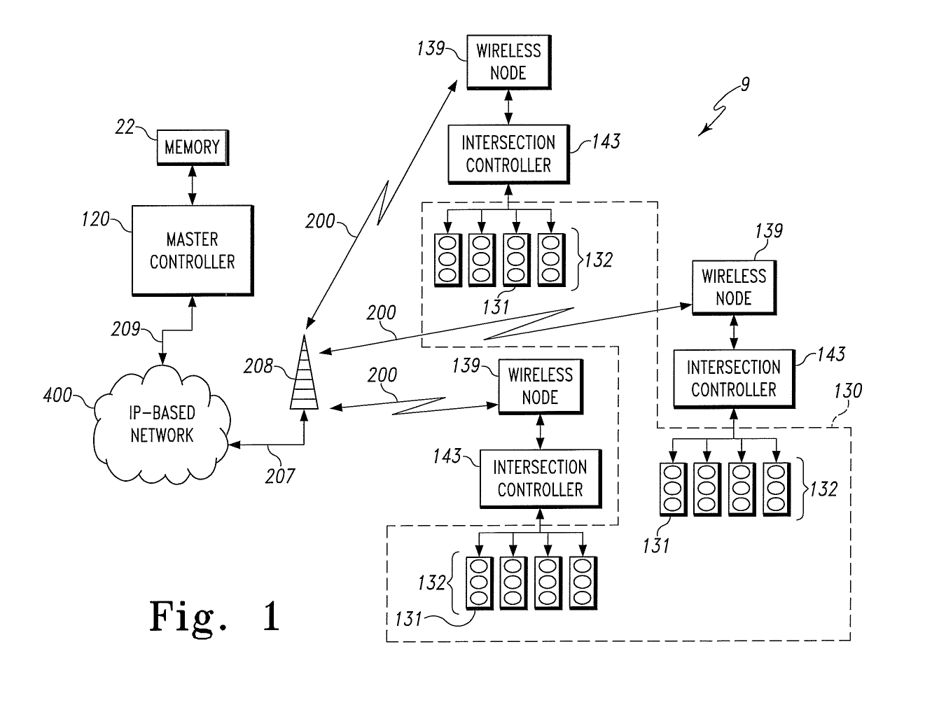

FIG. 1 is a block diagram representative of a system 9 to control a plurality of traffic signal lights in accordance with the present invention. The system 9 includes a master controller 120, a plurality wireless nodes 139, the plurality of traffic signal lights represented generally by the numeral 130, a wireless communication link (for example, a radio-frequency (RF) communication link) represented generally by the numeral 200, a communication tower 208, and a plurality of intersection controllers 143.

As defined herein, the term wireless node describes a medium access control and physical layer interface to a wireless medium. In one implementation of this embodiment, the wireless nodes 139 are Institute of Electrical and Electronics Engineers 802.11 conformant media access control and physical layer interfaces to the wireless medium and are also referred to herein as “wireless stations 139” or “local area network nodes 139.” In another implementation of this embodiment, the wireless nodes 139 are Institute of Electrical and Electronics Engineers 802.16 conformant medium access control and physical layer interfaces to a wireless medium and are also referred to herein as “metropolitan area network nodes 139.”

The plurality of wireless nodes 139 are communicatively coupled to the master controller 120 and at least one of the plurality of traffic signal lights 130 so that each traffic signal light is communicatively coupled to the master controller 120 via a wireless node 139. The plurality of wireless nodes 139 and the plurality of traffic signal lights 130 are dispersed in a geographic area. Each wireless node 139 in the plurality of wireless nodes is associated with a distinct Internet protocol address so that the signals sent to the wireless node 139 are transmitted from the master controller 120 via the Internet protocol based network 400, also referred to herein as an “IP-based network 400.” The intersection controllers 143 control the traffic signal lights represented generally by the numeral 131 that are located at one intersection. The group of traffic signal lights at one intersection is represented generally by the numeral 132 and is referred to herein as “intersection traffic signal lights 132.”

The wireless communication link 200 provides Internet protocol based communication between the plurality of wireless nodes 139 and the master controller 120. Each wireless node 139 receives control data packets for communicatively coupled traffic signal lights 131 from the master controller 120 via the wireless communication link 200. The control data packets comprise one of the distinct Internet protocol addresses and operational instructions for at least one traffic signal light 131 communicatively coupled to the wireless node 139. Each traffic signal light 131 is responsive to the operational instructions in the control data packets addressed to the associated distinct Internet protocol address.

In one implementation of this embodiment, each traffic signal light 131 in the plurality of traffic signal lights 130 is associated with a distinct Internet protocol address so that the signals to the traffic signal lights 130 are transmitted from the master controller 120 via an IP-based network 400. In another implementation of this embodiment, each intersection controller 143 is associated with a distinct Internet protocol address so that the signals are transmitted to the intersection controller 143 from the master controller 120 via the IP-based network 400.

In yet another implementation of this embodiment, the wireless communication link 200 is bidirectional. In this case, the bidirectional wireless communication link 200 transmits data upstream from the plurality of wireless nodes 139 to the master controller 120 in data packets including an Internet protocol address. In this manner, each wireless node 139 sends response data packets to the master controller 120 via the wireless communication link 200 in response to a received control data packet. In yet another implementation of this embodiment, each traffic signal light 131 sends data packets including information indicative of the status of the traffic signal lights 131 to the master controller 120 via the wireless node 139 and the wireless communication link 200. In yet another implementation of this embodiment, the master controller 120 receives updated traffic data from a traffic signal light 131 via the wireless node 139 and the wireless communication link 200. The terms “updated traffic data” and “traffic data” are used interchangeably in this document.

The communication from the communication tower 208 to the master controller 120 includes communication link 207 from the communication tower 208 to the IP-based network 400, and communication link 209 from the IP-based network 400 to the master controller 120.

The system 9 additionally includes a memory 22 that is communicatively coupled to the master controller 120 to store operational instructions for the each of the traffic signal lights 131. In one implementation of this embodiment, the memory 22 is internal to the master controller 120. In one implementation of this embodiment, the memory 22 stores a table of the operational instructions correlated to times, dates and distinct Internet protocol addresses, and the master controller 120 transmits the operational instructions for each distinct Internet protocol address based on a current date and time.

The master controller 120 receives traffic data associated with vehicular traffic being controlled by the plurality of traffic signal lights 130. In one implementation of this embodiment, the master controller 120 updates the operational instructions stored in the memory 120 based on the received traffic data when the traffic data is received. The updates are configured to modify the stored operational instructions for one or more of the distinct Internet protocol address. The updates are based on the traffic data received at the master controller 120. The traffic data is associated with the flow of vehicular traffic controlled by at least one of the traffic signal lights 131. In one implementation of this embodiment, the master controller 120 receives the updates from a traffic monitoring network (not shown). In another implementation of this embodiment, the master controller 120 receives the updates from the plurality of traffic signal lights 130.

In one implementation of this latter embodiment, there is no memory 22 in the system 9. In another implementation of this embodiment, the master controller transmits operational instructions to one or more of the plurality of traffic signal lights 130 based on the received traffic data. In yet another implementation of this embodiment, the master controller transmits operational instructions to one or more of the plurality of traffic signal lights 130 based on the received traffic data and also updates the operational instructions stored in the memory 120 based on the received traffic data when the traffic data is received.

The traffic data includes: traffic data associated with a current flow of vehicular traffic; the traffic data associated with a flow of vehicular traffic for the current day; the traffic data associated with a flow of vehicular traffic for the current week; the traffic data associated with a flow of vehicular traffic for the current month; the traffic data associated with a future flow of vehicular traffic; the traffic data associated with a flow of vehicular traffic for the next day; the traffic data associated with a flow of vehicular traffic for the next week; the traffic data associated with a flow of vehicular traffic for the next month; the traffic data associated with a current flow of vehicular traffic including an emergency vehicle; the traffic data associated with a flow of vehicular traffic including one or more routes under construction, the traffic data associated with a flow of vehicular traffic including one or more routes scheduled for upcoming construction, and combinations thereof.

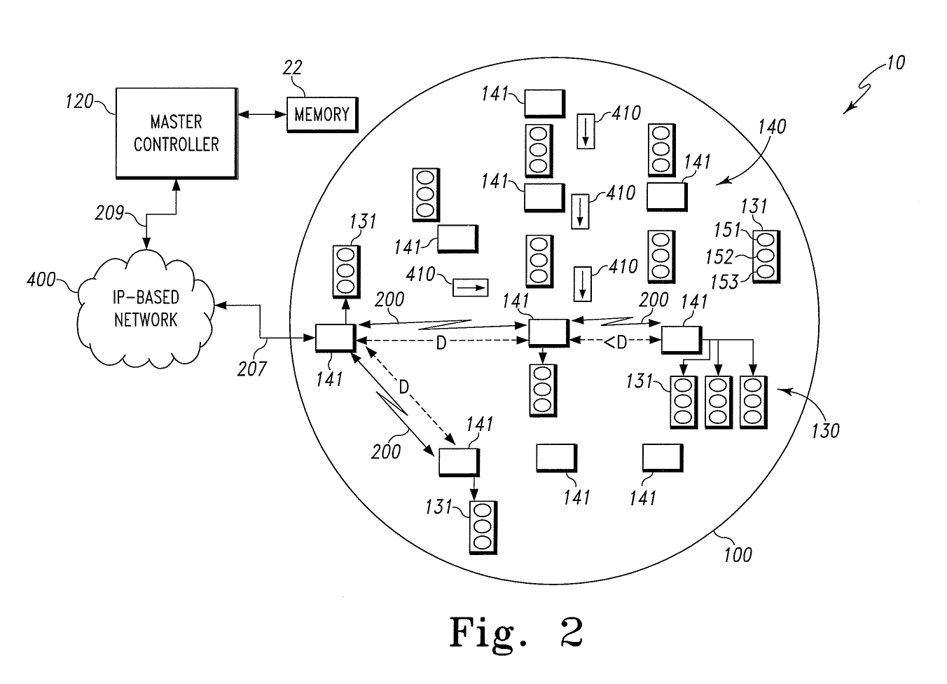

FIGS. 2-5 are a block diagrams representative of embodiments of systems 10-13, respectively, to control the plurality of traffic signal lights 130 in accordance with the present invention. The exemplary systems 10-13 represented in FIGS. 2-5, respectively, each include the master controller 120, the plurality of traffic signal lights 130, and the wireless communication link 200. The plurality of traffic signal lights 130 are dispersed in a geographic area represented generally by the circle 100. Movement of the vehicles 410 (as indicated by the vector inside the boxes representing the vehicle 410) is controlled by the color of the illuminated lamps represented generally by the numerals 151, 152, and 153 in the traffic signal lights 131. Some traffic signal lights include more than three lamps or fewer than three lamps.

The combined movements of all the vehicles 410 constitute a flow of vehicular traffic that is controlled by at least one of the plurality of traffic signal lights 130. When the systems 10-13 represented in FIGS. 2-5, respectively, are implemented, the systems 10-13 control the plurality of traffic signal lights 130 so that the vehicles 410 in the controlled flow of vehicular traffic encounter a reduced number of delays.

FIG. 2 is a block diagram representative of a system 10 to control the plurality of traffic signal lights 130 in which the wireless node is a wireless local area network node 141 that is conformant with Institute of Electrical and Electronics Engineers 802.11 standards. The system 10 includes the master controller 120, the plurality of traffic signal lights 130, the wireless communication link 200, the plurality of wireless local area network nodes 141, the IP-based network 400, and a memory 22. As shown in FIG. 2, the geographic area 100 encompasses the plurality wireless local area network nodes 141. Each wireless local area network node 141 is communicatively coupled to at least one traffic signal light 131 that comprises the intersection traffic signal lights 132 (FIG. 1).

Each wireless local area network node 141 is also communicatively coupled to at least one other wireless local area network node 141 so that at least a portion of the wireless communication link 200 includes multiple hops between three or more wireless local area network nodes 141. The wireless local area network nodes 141 that communicate with each other are positioned within a distance D from each other. In one implementation of this embodiment, the distance D is 1000 feet. In another implementation of this embodiment, the distance D is in the range form 100 to 500 feet. In yet another implementation of this embodiment, the distance D is less than 5 miles. In yet another implementation of this embodiment, the distance D is less than 70 miles.

At least one of the wireless local area network nodes 141 is communicatively coupled to the IP-based network 400 and the master controller 120 via the communication links 207 and 209. All the wireless local area network nodes 141 are communicatively coupled to at least one of the wireless local area network nodes 141 that is communicatively coupled to the master controller 120 via the IP-based network 400. In this manner, all of the wireless local area network nodes 141 are communicatively coupled with the master controller 120.

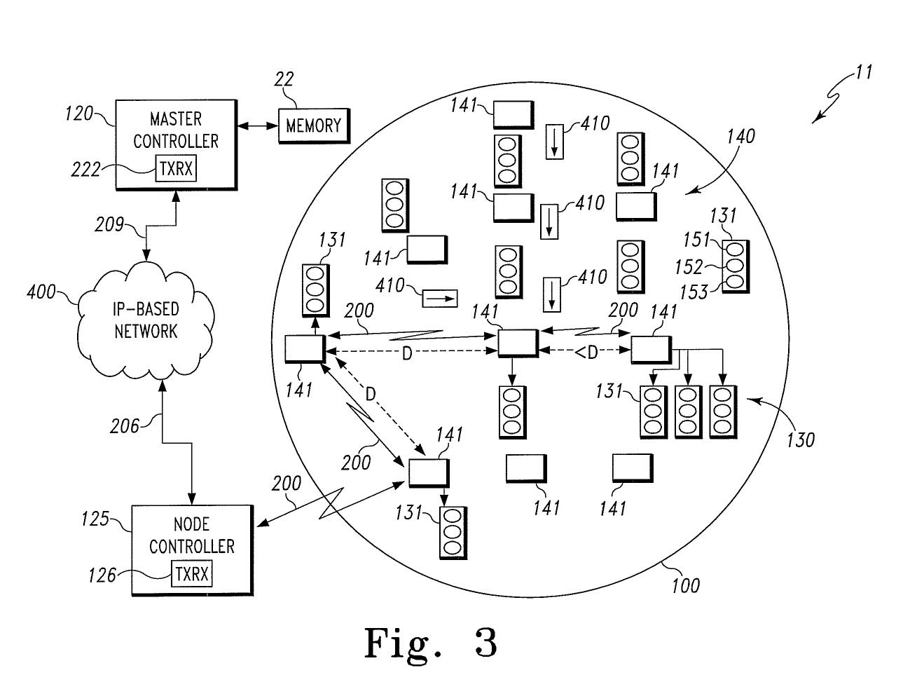

FIG. 3 is a block diagram representative of a system 11 to control a plurality of traffic signal lights. System 11 includes system 10 as described above with reference to FIG. 2, and a wireless local area network node controller 125 that is communicatively coupled to the plurality of wireless local area network nodes via an additional portion of the wireless communication link 200. The wireless local area network node controller 125 is communicatively coupled to the master controller via a communication link 206, the IP-based network 400, and the communication link 209.

In system 11, the master controller 120 includes a transceiver (TXRX) 222 to transmit the data packets to the wireless local area network node controller 125 via communication link 206, the IP-based network 400 and communication link 209. The wireless local area network node controller 125 includes a transceiver (TXRX) 126 to receive the data packets from the master controller 120. The transceiver 126 sends the data packets to the addressed traffic signal light 131 based on the Internet protocol address.

In one implementation of this embodiment, the wireless communication link 200, the communication link 206 and the communication link 209 are bidirectional. In this case, the transceiver 126 receives data from each of the traffic signal lights 131 and sends the data to the transceiver 222 in the master controller 120 via communication link 206, the IP-based network 400 and communication link 209. In one implementation of this embodiment, the wireless local area network node controller 125 time-division multiplexes the data that is received from the traffic signal lights 131 to transmit it to the master controller 120.

As shown in FIG. 3, the master controller 120 is communicatively coupled to a memory 22, which functions as described above with reference to FIG. 1. As shown in FIG. 3, the memory 22 is separate from the master controller 120. In one implementation of this embodiment, the memory 22 is part of the master controller 120. In either implementation, the memory 22 is communicatively coupled to the master controller 120 by a wireless communication link (for example, a radio-frequency (RF) communication link) and/or a wired communication link (for example, an optical fiber or copper wire communication link).

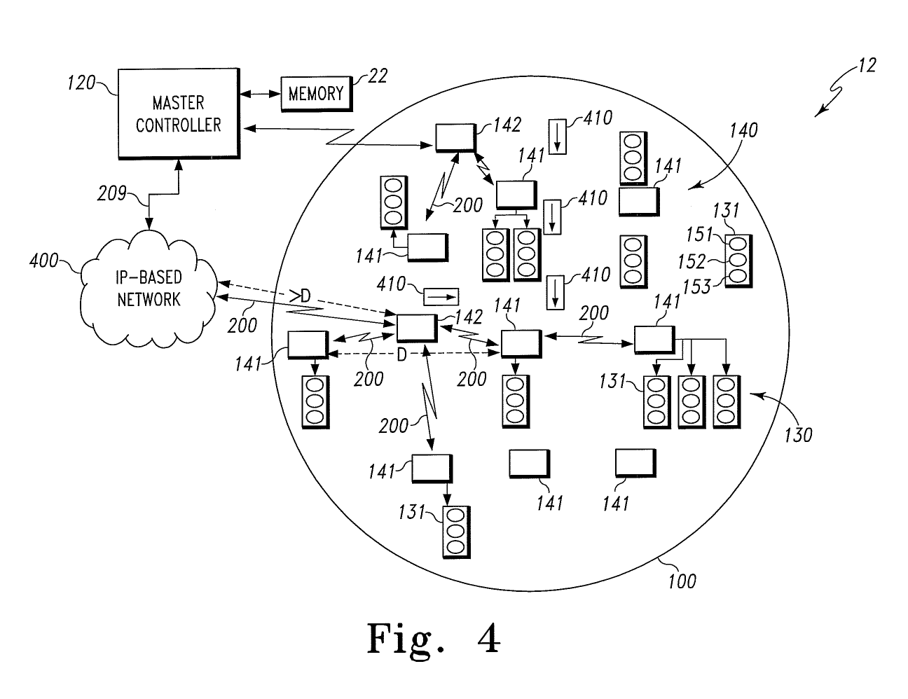

FIG. 4 is a block diagram representative of a system 12 to control the plurality of traffic signal lights 130. System 12 differs from system 10 of FIG. 2 by the inclusion of at least one wireless metropolitan area network node 142 that forms a portion of the communication link between the wireless local area network nodes 141 and the master controller 120. The wireless metropolitan area network nodes 142 (also referred to herein as wireless nodes 142) are Institute of Electrical and Electronics Engineers 802.16 conformant media access control and physical layer interfaces to the wireless medium. The Institute of Electrical and Electronics Engineers 802.16 standard specifies the air interface of fixed broadband wireless access systems supporting multimedia services. The medium access control layer supports a primarily point-to-multipoint architecture, with an optional mesh topology. The medium access control layer is structured to support multiple physical layer specifications, each suited to a particular operational environment. For operational frequencies from 10-66 GHz, the physical layer is based on single-carrier modulation. For frequencies below 11 GHz, where propagation without a direct line of sight must be accommodated, three alternatives are provided, using OFDM, OFDMA, and single-carrier modulation. The wireless nodes 142 are used in a mesh network and, in some implementations of this embodiment, behave as a base station, a subscriber station or both.

In system 12, the wireless local area network nodes 141 communicate with each other and with a wireless metropolitan area network node 142. The wireless metropolitan area network node 142 then communicates with the master controller 120 via the IP-based network 400 and wireless communication link 200. The communication range for the wireless metropolitan area network node 142 normally exceeds the communication range, such as the distance D, of the wireless local area network nodes 141.

As shown in FIG. 4, the geographic area 100 encompasses at least one wireless metropolitan area network node 142 and the plurality of wireless local area network nodes 141.

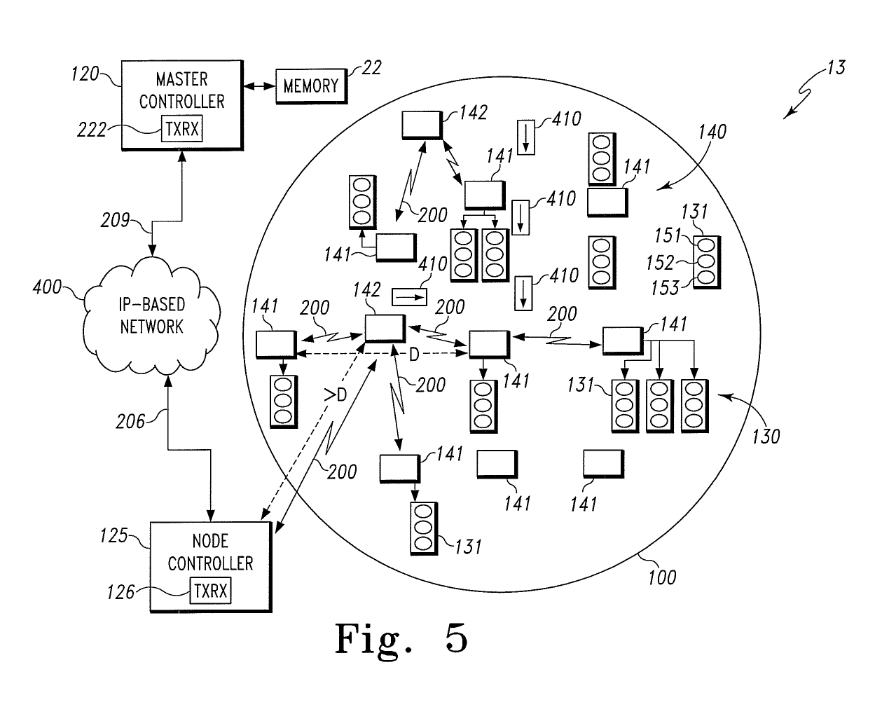

FIG. 5 is a block diagram representative of a system 13 to control the plurality of traffic signal lights 130. System 13 differs from system 11 of FIG. 3 by the inclusion of a wireless metropolitan area network node 142 (as described above with reference to FIG. 4) that forms a portion of the communication link between the wireless local area network nodes 141 and the master controller 120. In system 13, the wireless local area network nodes 141 communicate with each other and with the wireless metropolitan area network node 142. The wireless metropolitan area network node 142 then communicates with the master controller 120 via the node controller 125, the IP-based network 400, the wireless communication link 200, and communication links 206 and 209.

As shown in FIG. 5, the geographic area 100 encompasses at least one wireless metropolitan area network node 142 and the plurality of wireless local area network nodes 141.

The intersection controller 143 is not shown in FIGS. 2-5 in order to simplify the drawings, although in some implementations of this embodiment, at least one intersection controller (FIG. 1) is implemented as a connection between the at least one wireless node 141 and/or 142 and the associated intersection traffic signal lights 132 (FIG. 1).

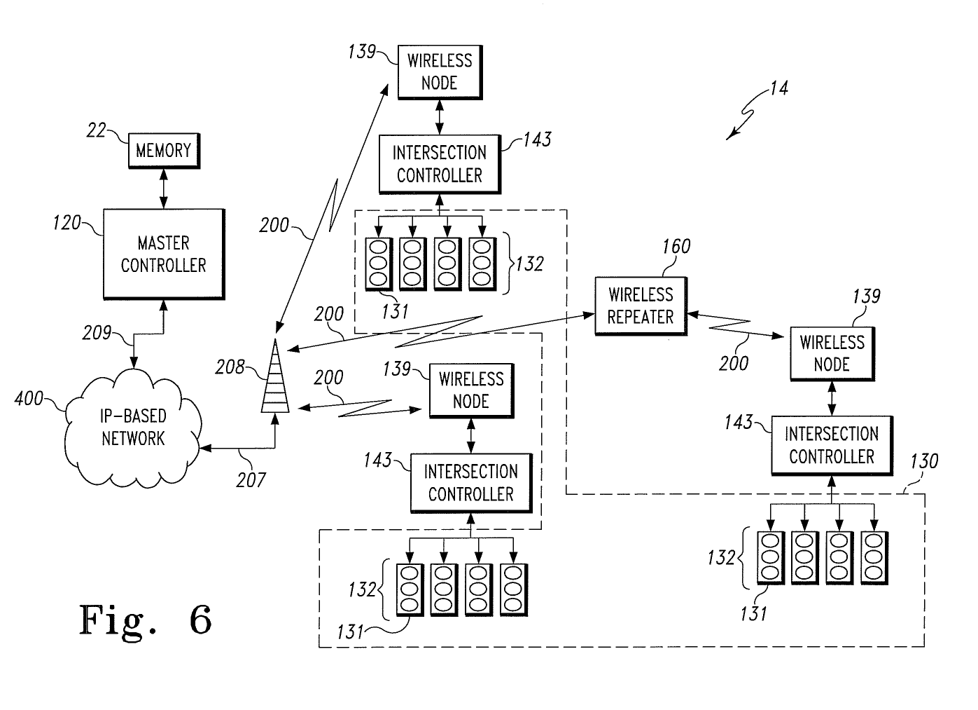

FIG. 6 is a block diagram representative of a system 14 to control a plurality of traffic signal lights 130 in accordance with the present invention. System 14 differs from system 9 of FIG. 1 in that a wireless repeater 60 is communicatively coupled with at least one of the wireless nodes 139. The wireless repeater 160 is compliant with at least one of the Institute of Electrical and Electronics Engineers 802.16 standards and the Institute of Electrical and Electronics Engineers 802.11 standards. Each wireless node 139 is communicatively coupled to the traffic signal lights 131 via one of the intersection controllers 143 as described above with reference to FIG. 1.

In one implementation of this embodiment, the wireless nodes 139 and the wireless repeater 160 are Institute of Electrical and Electronics Engineers 802.11 compliant wireless nodes. In another implementation of this embodiment, the wireless nodes 139 are Institute of Electrical and Electronics Engineers 802.11 compliant wireless stations and the wireless repeater 160 is an Institute of Electrical and Electronics Engineers 802.16 compliant wireless node. In yet another implementation of this embodiment, the wireless nodes 139 are Institute of Electrical and Electronics Engineers 802.16 compliant wireless stations and the wireless repeater 160 is an Institute of Electrical and Electronics Engineers 802.11 compliant wireless node. In yet another implementation of this embodiment, the wireless nodes 139 and the wireless repeater 160 are Institute of Electrical and Electronics Engineers 802.16 compliant wireless nodes. In yet another implementation of this embodiment, wireless repeater 160 is compliant with either the Institute of Electrical and Electronics Engineers 802.16 standards or the Institute of Electrical and Electronics Engineers 802.11 standards and the wireless nodes 139 are compliant with either the Institute of Electrical and Electronics Engineers 802.16 standards or the Institute of Electrical and Electronics Engineers 802.11 standards. In yet another implementation of this embodiment, the wireless nodes 139 and the wireless repeater 160 are Evolution Data Only/Evolution Data Optimized (for example, EVDO, EV-DO, EvDO, 1xEV-DO or 1xEvDO) compliant.

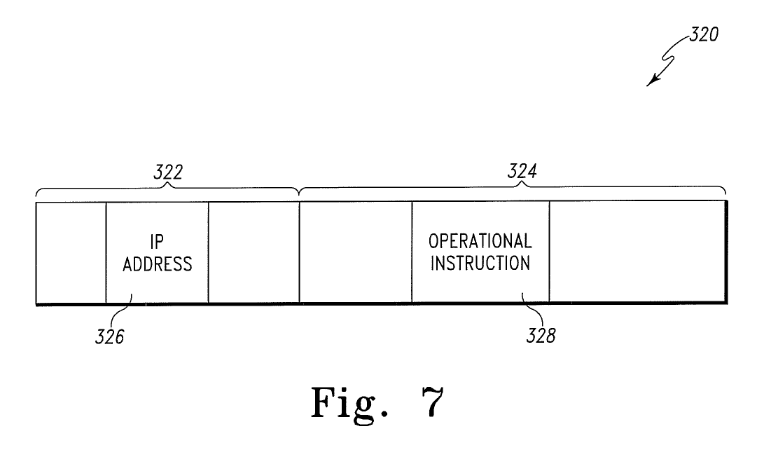

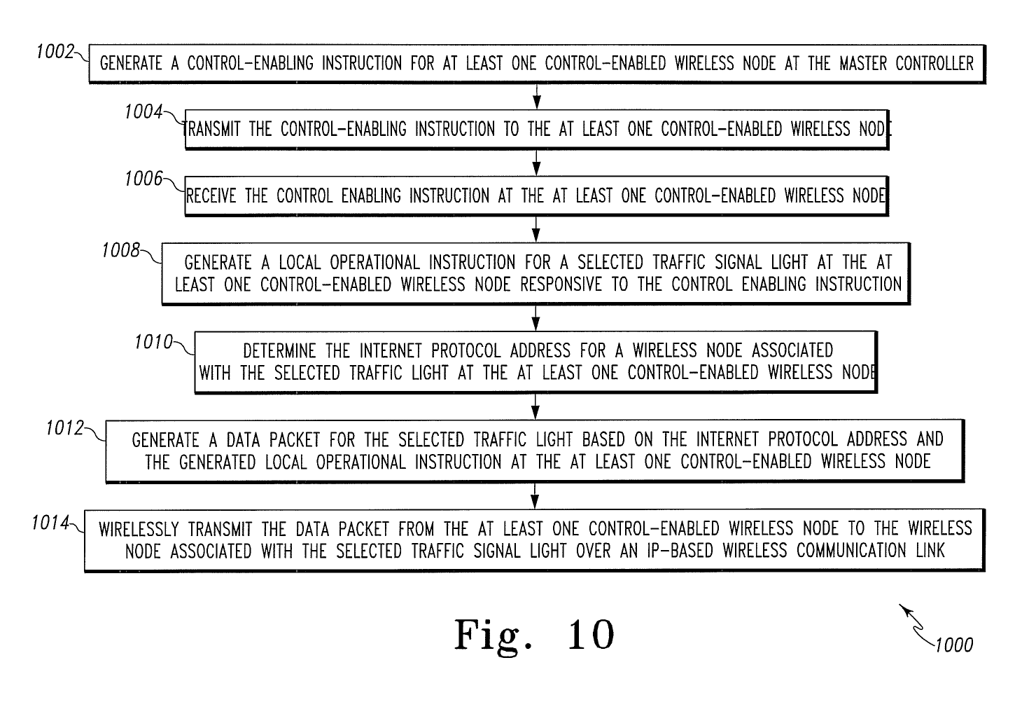

FIG. 7 is a block diagram representative of a data packet 320 transmitted between a traffic signal light and a master controller. The data packet 320 includes a header 322 and a load 324. The address information, including the IP address 326 is included in the header 322. When the operational instructions 328 for each of the traffic signal lights are included in the load 324 of the data packet 320, the data packet 320 is referred to as a “control data packet 320.” In one implementation of this embodiment, the operational instruction 328 of the data packet 320 is a local operational instruction 328. The function of a local operational instruction 328 is described below with reference to method 1000 of FIG. 10. In another implementation of this embodiment, the data packet 320 includes status data about the status of a traffic signal light. In this case, the operational instructions 328 are replaced by the status data and the data packet 320 is referred to as a “status data packet 320.”

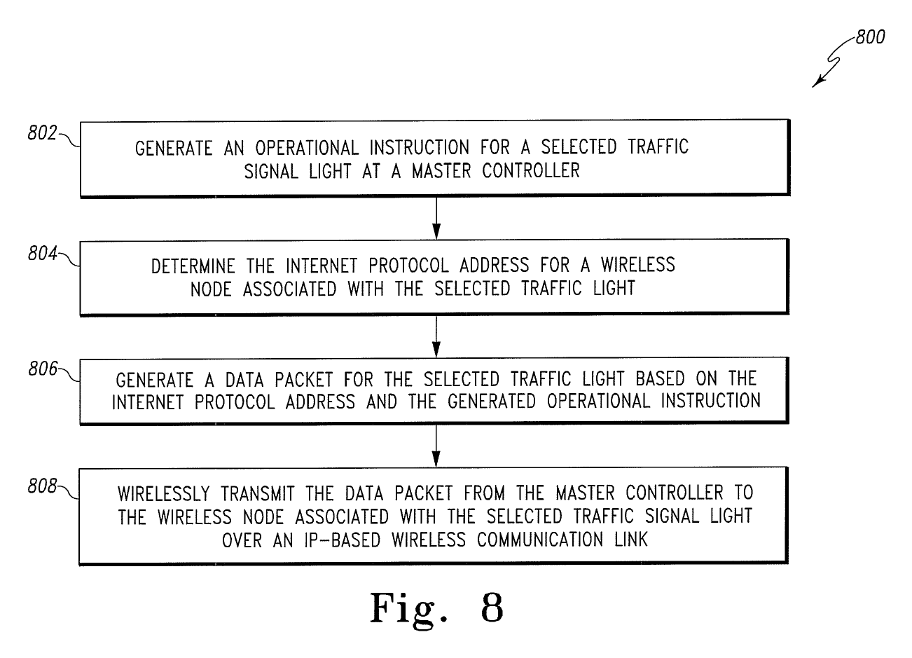

FIG. 8 is a flow diagram of one embodiment of a method 800 to control a plurality of traffic signal lights in accordance with the present invention.

At block 802, the master controller generates an operational instruction for a selected traffic signal light. In one implementation of this embodiment, the master controller 120 of system 9 (FIG. 1) generates an operational instruction for a selected traffic signal light 131.

At block 804, the master controller determines the Internet protocol address for a wireless node associated with the selected traffic signal light. In one implementation of this embodiment, the master controller 120 determines the Internet protocol address 326 (FIG. 7) for the wireless node 139 associated with the selected traffic signal light 131. At block 806, the master controller generates a data packet for the selected traffic signal light based on the Internet protocol address of the wireless node associated with the selected traffic signal light and the generated operational instruction. In one implementation of this embodiment, the master controller 120 generates a data packet 320 (FIG. 7) for the selected traffic signal light 131 based on the Internet protocol address 326 of the wireless node 139 associated with the selected traffic signal light 131 and the generated operational instruction 328, which is included in the load 324 of the data packet 320. At block 808, the master controller wirelessly transmits the data packet to the wireless node associated with the selected traffic signal light over an IP-based wireless communication link. In one implementation of this embodiment, the master controller 120 of system 9 wirelessly transmits the data packet 320 (FIG. 7) to the wireless node 139 associated with the selected traffic signal light 131 over an IP-based wireless communication link 200.

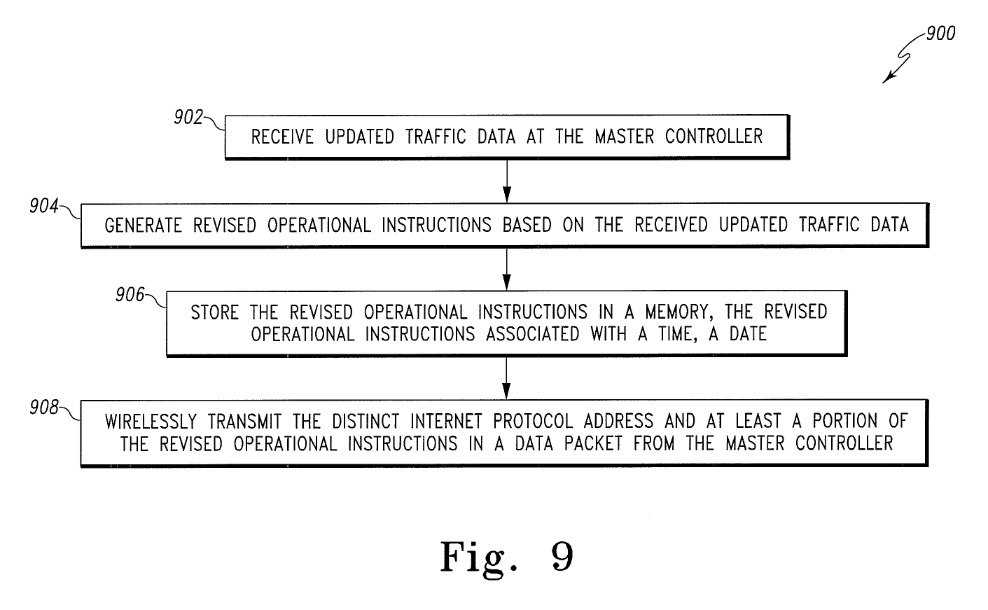

FIG. 9 is a flow diagram of one embodiment of a method 900 to update traffic data at a master controller in accordance with the present invention. At block 902, the master controller receives updated traffic data. The updated traffic data is related to a flow of vehicular traffic controlled by at least one of the plurality of traffic signal lights. In one implementation of this embodiment, the master controller 120 receives updated traffic data from an external source, such as a traffic control database. In another implementation of this embodiment, the master controller 120 receives updated traffic data that is input by a user of the IP-based network 400. In another implementation of this embodiment, the master controller 120 receives updated traffic data from a traffic signal light 131 via the wireless communication link 200. The updated traffic data comprises one of video data, security data, traffic management data, traffic signal light status data, acknowledgement data, current traffic flow data, emergency vehicle over-ride data, and combinations thereof.

At block 904, the master controller generates revised operational instructions based on the received updated traffic data. In an exemplary case, the updated traffic data indicates that the traffic signal light 131 associated with a wireless node 139 that has a specific IP address intersects with a parade route for a period of time the following day. In this case, the master controller 120 of system 10 in FIG. 2 generates revised operational instructions to instruct the traffic signal light 131 associated with the wireless node 139 that has the IP address to illuminate the red signal lamp 151 (FIG. 2) for the duration of the parade time.

At block 906, the master controller stores the revised operational instructions in a memory. The revised operational instructions are associated with a time and a date, such as for example the time and the date of the parade in the exemplary case mentioned above. In one implementation of this embodiment, the master controller 120 stores the revised operational instructions in the memory 22 (FIG. 1). In another implementation of this embodiment, block 906 is not implemented in method 900.

At block 908, the master controller wirelessly transmits the distinct Internet protocol address and at least a portion of the revised operational instructions in a data packet. In one implementation of this embodiment, the master controller 120 of system 10 in FIG. 2 wirelessly transmits the distinct Internet protocol address 326 and at least a portion of the revised operational instructions 328 in a data packet 320 (FIG. 7).

FIG. 10 is a flow diagram of one embodiment of a method 1000 to control a plurality of traffic signal lights in accordance with the present invention.

At block 1002, the master controller generates a control-enabling instruction for at least one control-enabled wireless node at the master controller. A control-enabled wireless node is a wireless node that is targeted to receive the control-enabling instruction and that includes the hardware and software to function as a master controller in response to receiving a control-enabling instruction. In one implementation of this embodiment, the master controller 120 generates the control-enabling instruction for one of the wireless nodes 141 in system 10 (FIG. 2). In another implementation of this embodiment, at the master controller the master controller 120 generates the control-enabling instruction for all of the wireless nodes 141 in system 10. In one implementation of this embodiment, the master controller 120 generates the control-enabling instruction for one of the wireless nodes 141 or 142 in system 13 (FIG. 5). In another implementation of this embodiment, at the master controller the master controller 120 generates the control-enabling instruction for all of the wireless nodes 141 and 142 in system 13.

Block 1002 occurs when a determination is made at the master controller to transfer some or all of the system control from the master controller to one or more of the wireless nodes in the system.

At block 1004, the master controller transmits the control-enabling instruction to the at least one control-enabled wireless node. In one implementation of this embodiment, the master controller 120 transmits the control-enabling instruction that was generated at block 1002 to one control-enabled wireless node 141 in system 10, which was described above with reference to FIG. 2.

At block 1006, the control-enabled wireless node receives the control enabling instruction that was sent at block 1004 from the master controller. The control-enabled wireless node functions as the master controller (as described above with reference to method 800 of FIG. 8) responsive to receiving the control-enabling instruction. In one implementation of this embodiment, the control-enabled wireless node 141 receives the control enabling instruction that was sent at block 1004 from the master controller 120

At block 1008, the control-enabled wireless node generates a local operational instruction for a selected traffic signal light responsive to the receiving the control enabling instruction. In one implementation of this embodiment, the control-enabled wireless node 141 generates a local operational instruction for a selected traffic signal light 131 responsive to the receiving the control enabling instruction from the master controller 120.

At block 1010, the control-enabled wireless node determines the Internet protocol address for a wireless node associated with the selected traffic. In one implementation of this embodiment, the control-enabled wireless node 141 determines the Internet protocol address for another of the wireless nodes 141 associated with the selected traffic signal lights 131.

At block 1012, the control-enabled wireless node generates a data packet for the selected traffic signal light based on the Internet protocol address and the generated local operational instruction. In one implementation of this embodiment, the control-enabled wireless node 141 generates the data packet 320 (FIG. 7) for the selected traffic signal light 131 based on the Internet protocol address and the generated local operational instruction. In this case, the operational instruction 328 of the data packet 320 is a local operational instruction 328.

At block 1014, the control-enabled wireless node wirelessly transmits the data packet to the wireless node associated with the selected traffic signal light over an IP-based wireless communication link. In one implementation of this embodiment, the control-enabled wireless node 141 wirelessly transmits the data packet 320 to the wireless node 141 associated with the selected traffic signal light 131 over an IP-based wireless communication link 200.

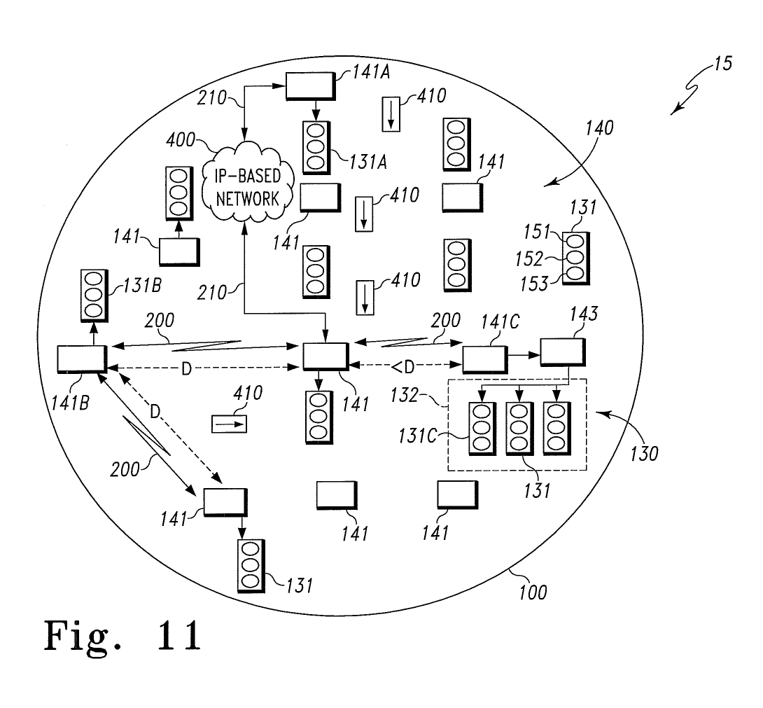

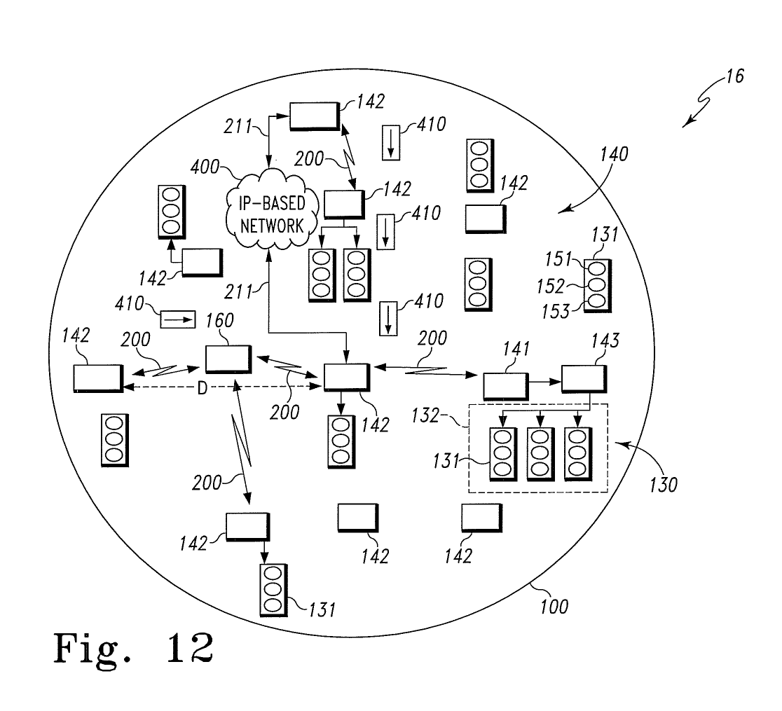

FIGS. 11 and 12 are a block diagrams representative of embodiments of systems 15 and 16, respectively, to control a plurality of traffic signal lights in accordance with the present invention. FIGS. 11 and 12 differ from FIGS. 2-5 in that systems of FIGS. 11 and 12 do not include a master controller.

FIG. 11 is a block diagram representative of an embodiment of system 15 to control a plurality of traffic signal lights in accordance with the present invention. System 15 includes wireless nodes dispersed in a geographic area 100 and configured in the manner of the wireless nodes 141 as described above with reference to system 10 of FIG. 2. In system 15, the IP based network 400 is distributed among or between the wireless nodes 141. Intersection controllers 143 (only one of which is shown in FIG. 11) associated with a respective one of the plurality of wireless nodes 141 control at least one traffic signal light 131 so that at least one wireless local area network node 141 is communicatively coupled to the intersection traffic signal lights 132 via one of the intersection controllers 143.

As shown in FIG. 11, at least one wireless node 141 is communicatively coupled to another wireless node 141 via the IP-based network 400 and communication links 210. The communication links 210 provide communicative coupling between the IP-based network 400 and the wireless nodes 141. Likewise, at least one wireless node 141 in system 15 is communicatively coupled to another wireless node via the IP-based network 400, communication link 200, and communication link 210. Additionally, at least one wireless node 141 in system 15 is communicatively coupled to another wireless node 141 via the communication link 210.

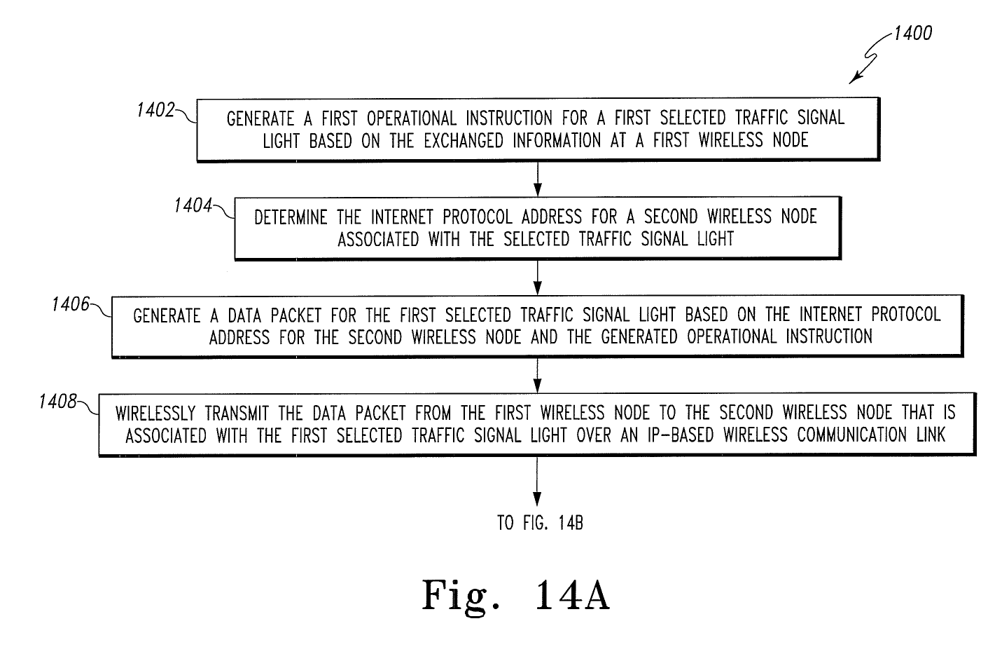

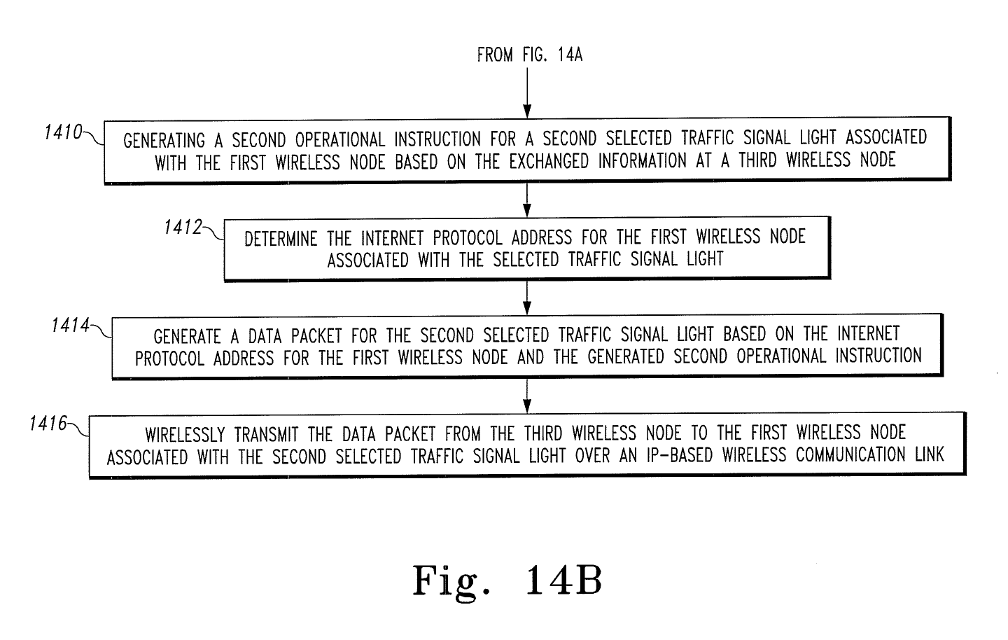

Three of the wireless nodes 141 and two of the traffic signal lights 131 in FIG. 11 include an alphabetical label with the numerical label 141. These wireless nodes are 141A, 141B and 141C. These traffic signal lights are traffic signal light 131B associated with the wireless node 141B and the traffic signal light 131C associated with the wireless node 141C. This alphabetical labeling is used to facilitated an exemplary description of the method 1400 described below with reference to FIGS. 14A and 14B. The wireless nodes are 141A, 141B and 141C are similar in function and structure to the wireless nodes 141. The traffic signal light 131B and the traffic signal light 131C are similar in function and structure to the traffic signal lights 131.

FIG. 12 is a block diagram representative of an embodiment of system 16 to control a plurality of traffic signal lights in accordance with the present invention. System 16 includes wireless nodes dispersed in a geographic area 100 and configured in the manner of the wireless nodes 142 as described above with reference to system 12 of FIG. 4. In system 16, the IP based network 400 is distributed among or between the wireless nodes 142 and a wireless repeater 160 (FIG. 6). Intersection controllers 143 (only one of which is shown in FIG. 12) associated with a one of the plurality of wireless nodes 142 control at least one traffic signal light 131 so that at least one wireless local area network node 142 is communicatively coupled to the intersection traffic signal lights 132 via one of the intersection controllers 143.

As shown in FIG. 12, at least one wireless node 142 is communicatively coupled to another wireless node 142 via the IP-based network 400 and communication links 211. The communication links 211 provide communicative coupling between the IP-based network 400 and the wireless nodes 141. Likewise, at least one wireless node 142 is communicatively coupled to another wireless node 142 via the IP-based network 400, communication link 200, and the wireless repeater 160. Additionally, at least one wireless node 142 is communicatively coupled to another wireless node 142 via the communication link 200, and the wireless repeater 160. Additionally, at least one wireless node 142 is communicatively coupled to another wireless node 142 via the communication link 200.

Within systems 15 and 16, each wireless node 141 or 142 in the plurality of wireless nodes 141 or 142 is associated with a distinct Internet protocol address. The plurality of traffic signal lights 130 are dispersed in the geographic area 100 and each of the traffic signal lights 131 is communicatively coupled to a respective one of the plurality of wireless nodes 141 or 142. A wireless communication link 200 provides Internet protocol based communication among the plurality of wireless nodes 141 and/or 142. Each of the plurality of wireless nodes 141 or 142 receives control data packets, such as data packet 320 (FIG. 7), from others of the plurality of wireless nodes 141 or 142. These control data packets include one of the distinct Internet protocol addresses 326 (FIG. 7) and operational instructions 328 (FIG. 7) for the at least one traffic signal light 131 communicatively coupled to the wireless node 141 or 142 that sends the control data packet 320. The traffic signal light 131 having the Internet protocol address 326 is responsive to the operational instructions 328 in the control data packets 320 addressed to the distinct Internet protocol address 326.

In one implementation of embodiments of systems 15 and 16, the wireless communication links 200 and communication link 210 or 211 are bidirectional. The bidirectional wireless communication links 200 transmits data between wireless nodes 141 and/or 142 in data packets. The transmitted data includes updated traffic data.

In implementations of embodiments described herein, one or more of the communication links 206, 207, 209, 210, and 211 are a wired communication link (for example, an optical fiber or copper wire communication link). In other implementations, one or more of the communication links 206, 207, 209, 210, and 211 are combinations of a wired and a wireless link. In yet another implementation of this embodiment, the communication links 206, 207, 209, 210, and 211 are wireless communication links that are integral to the communication link 200.

In implementations of embodiments described herein, the Internet protocol based communication is provided according to standards set by one of Institute of Electrical and Electronics Engineers 802.11, Institute of Electrical and Electronics Engineers 802.11a, Institute of Electrical and Electronics Engineers 802.11b, Institute of Electrical and Electronics Engineers 802.11g, Institute of Electrical and Electronics Engineers 802.11n, Institute of Electrical and Electronics Engineers 802.11p, Institute of Electrical and Electronics Engineers 802.16, Institute of Electrical and Electronics Engineers 802.16a, wireless local area network standards, wireless metropolitan area network standards, WiBro standards, Institute of Electrical and Electronics Engineers 802 standards, Evolution Data Only/Evolution Data Optimized standards (for example, EVDO, EV-DO, EvDO, 1xEV-DO or 1xEvDO), Orthogonal Frequency Division Multiplexing standards, time-division multiplexing standards, and combinations thereof. In implementations of embodiments described herein, the Internet protocol based communication is provided according to standards yet to be developed for wireless stations and/or wireless nodes, such as Institute of Electrical and Electronics Engineers 802.11x standards.

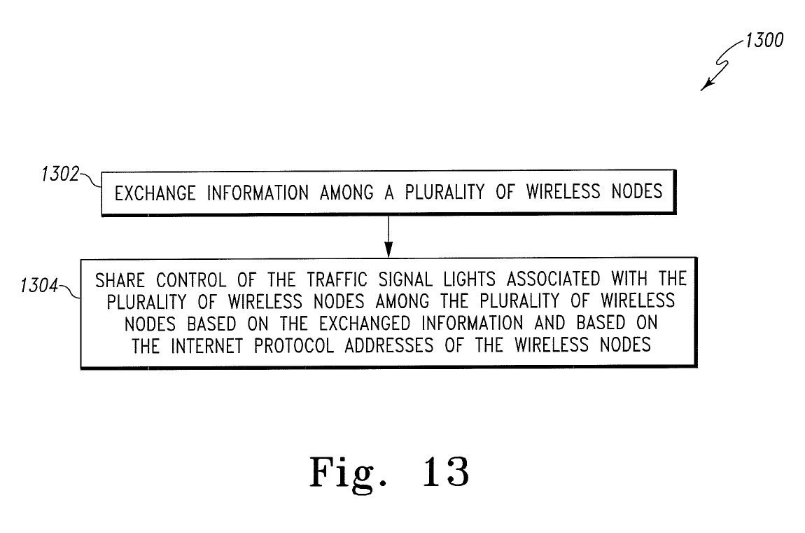

FIG. 13 is a flow diagram of one embodiment of a method 1300 to control a plurality of traffic signal lights in accordance with the present invention. Method 1300 is described as being implemented within system 15 of FIG. 11, although method 1300 is also applicable to system 16 of FIG. 12.

At block 1302, a plurality of wireless nodes exchange information. Each of the plurality of wireless nodes is associated with a distinct Internet protocol address and at least one of traffic signal lights. In one implementation of this embodiment, the plurality of wireless nodes 141 (FIG. 11), each associated with a distinct Internet protocol address and at least one of traffic signal lights 131, exchange information with each other.

At block 1304, the plurality of wireless nodes share control of the associated traffic signal lights with each other based on the exchanged information and based on the Internet protocol addresses of the wireless nodes. In one implementation of this embodiment, the plurality of wireless nodes 141 share control of the associated traffic signal lights 131 with each other.

FIGS. 14A and 14B are a flow diagram of one embodiment of a method 1400 to share control of traffic signal lights in accordance with the present invention. Method 1400 is described as being implemented within system 15 of FIG. 11, although method 1400 is also applicable to system 16 of FIG. 12.

At block 1402, a first wireless node generates an operational instruction for a selected traffic signal light. The operational instruction is based on the information exchanged during block 1302 of method 1300 described above with reference to FIG. 13. In one implementation of this embodiment, the selected traffic signal light is a first selected traffic signal light and the operational instruction is a first operational instruction. In this case, the first wireless node generates a first operational instruction for a first selected traffic signal light based on the exchanged information. In one implementation of this embodiment, the first wireless node 141A (FIG. 11) generates a first operational instruction for a first selected traffic signal 131B (FIG. 11) light based on the exchanged information.

At block 1404, the first wireless node determines the Internet protocol address for a second wireless node associated with the selected traffic signal light. In one implementation of this embodiment, the first wireless node 141A determines the Internet protocol address for a second wireless node 141B in the system 15 (FIG. 11) associated with the first selected traffic signal light 131B.

At block 1406, the first wireless node generates a data packet for the first selected traffic signal light based on the Internet protocol address for the second wireless node and the operational instruction generated at block 1402. In one implementation of this embodiment, the first wireless node 141A generates a data packet for the first selected traffic signal light 131B based on the Internet protocol address for the second wireless node 141B and the operational instruction generated at block 1402

At block 1408, the first wireless node wirelessly transmits the data packet from the first wireless node to the second wireless node that is associated with the first selected traffic signal light over an IP-based wireless communication link. In one implementation of this embodiment, the first wireless node 141A wirelessly transmits the data packet to the second wireless node 141B over an IP-based wireless communication link 200 and communication link 210.

The first wireless node 141A can also receive operational instructions from other wireless nodes in the system 15 of FIG. 10. At block 1410, a third wireless node generates a second operational instruction for a second selected traffic signal light associated with the first wireless node based on the exchanged information. In one implementation of this embodiment, the third wireless node 141C (FIG. 11) generates a second operational instruction for a second selected traffic signal light 131A associated with the first wireless node 141A based on the information exchanged at block 1302 of method 1300 described above with reference to FIG. 13.

At block 1412, the third wireless node determines the Internet protocol address for the first wireless node associated with the second selected traffic signal light. In one implementation of this embodiment, the third wireless node 141C determines the Internet protocol address for the first wireless node 141A associated with the second selected traffic signal light 131A.

At block 1414, the third wireless node generates a data packet for the second selected traffic signal light based on the Internet protocol address for the first wireless node and the generated second operational instruction. In one implementation of this embodiment, the third wireless node 141C generates a data packet for the second selected traffic signal light 131A based on the Internet protocol address for the first wireless node 141A and the generated second operational instruction.

At block 1416, the third wireless node wirelessly transmits the data packet from the third wireless node to the first wireless node associated with the second selected traffic signal light over an IP-based wireless communication link. In one implementation of this embodiment, the third wireless node 141C wirelessly transmits the data packet to the first wireless node 141A associated with the second selected traffic signal light 131A over an IP-based wireless communication link 200.

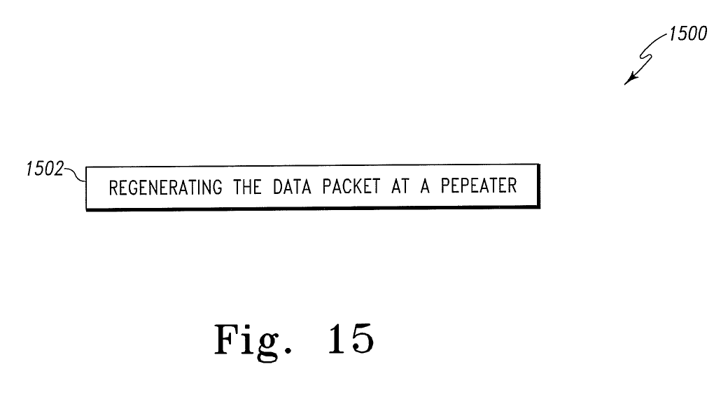

FIG. 15 is a flow diagram of one embodiment of a method 1500 to wirelessly transmit the data packet from at least one wireless node. At block 1502, the repeater regenerates the data packet. The repeater receives the data packet, regenerates and/or amplifies the signals in the data packet and transmits the regenerated data packet. In one implementation of this embodiment, block 1502 is implemented during block 808 as described above with reference to method 800 of FIG. 8. In such an implementation, the master controller 120 of system 14 wirelessly transmits the data packet 320 (FIG. 7) to the wireless node 139 associated with the selected traffic signal light 131 over an IP-based wireless communication link 200. In another implementation of this embodiment, block 1502 is implemented during block 1014, as described above with reference to method 1000 of FIG. 10. In yet another implementation of this embodiment, block 1502 is implemented during blocks 1408 and/or 1416, as described above with reference to method 1400 of FIGS. 14A and 14B.

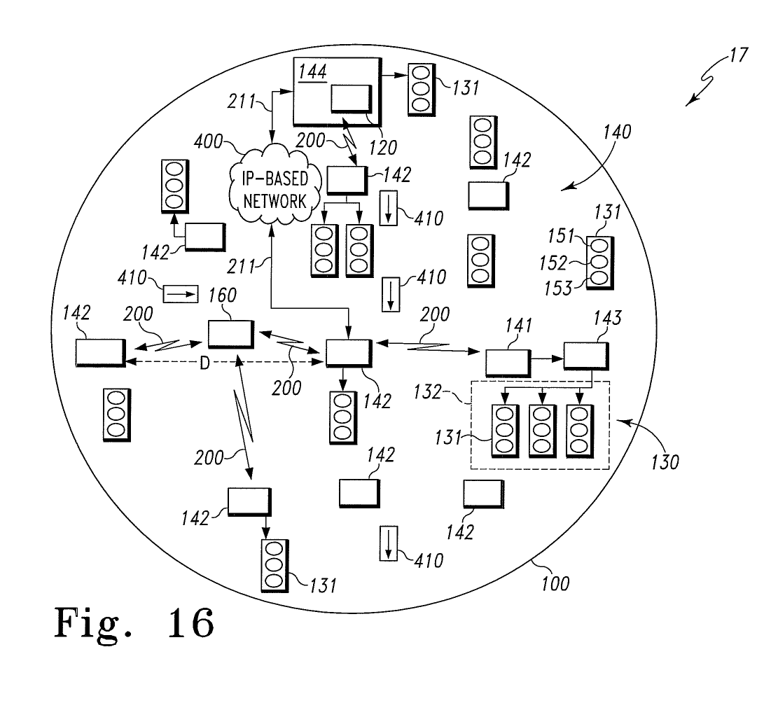

FIG. 16 is a block diagram representative of an embodiment of system 17 to control a plurality of traffic signal lights in accordance with the present invention. System 17 includes wireless nodes dispersed in a geographic area 100 and configured in the manner of the wireless nodes 142 as described above with reference to system 16 of FIG. 12. In one implementation of this embodiment, system 17 differs from system 16 in that one at least one wireless node includes a master controller, such as master controller 120 as described above with reference to FIG. 1. The wireless node which includes the master controller 120 is referred to herein as a “controlling wireless node 144.”

In another implementation of this embodiment, system 17 differs from system 12 as described above with reference to FIG. 4 in that the master controller 120 is included in at least one wireless node and the repeater, which functions as repeater 142 in system 12, functions as wireless repeater 160 in system 17. The controlling wireless node 144 is communicatively coupled to all the wireless nodes associated with a distinct Internet protocol address in the system 17. A wireless communication link 200 provides Internet protocol based communication between the plurality of wireless nodes 142 and the master controller 120 in the controlling wireless node 144. The master controller 120 in the controlling wireless node 144 sends control data packets for the traffic signal lights 131 that are communicatively coupled to the wireless nodes 142 via the wireless communication link 200.

In one implementation of this embodiment, the controlling wireless node 144 is communicatively coupled to the master controller 120 via a conductive line, such as a trace line or a wire. In this case, the master controller 120 in the controlling wireless node 144 sends control data packets for the traffic signal lights 131 that are communicatively coupled to the controlling wireless node 144 via the conductive line. In another implementation of this embodiment, the controlling wireless node 144 is communicatively coupled to the master controller 120 via a wireless communication link 200. In this case, the master controller 120 in the controlling wireless node 144 sends control data packets for the traffic signal lights 131 that are communicatively coupled to the controlling wireless node 144 via the wireless communication link 200, which is a very short range wireless communication link.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents.

What is claimed is:

1. A system, comprising:
a master controller;
a plurality of wireless nodes dispersed in a geographic area, the plurality of wireless nodes communicatively coupled to the master controller; and
a plurality of traffic signal lights dispersed in the geographic area, the traffic signal lights communicatively coupled to the master controller via the plurality of wireless nodes, wherein each wireless node in the plurality of wireless nodes is associated with a distinct Internet protocol address, wherein a wireless communication link provides Internet protocol based communication between the plurality of wireless nodes and the master controller, wherein the plurality of wireless nodes receives control data packets for the communicatively coupled traffic signal lights from the master controller via the wireless communication link, wherein the control data packets comprise one of the distinct Internet protocol addresses and operational instructions for the at least one traffic signal light communicatively coupled to the wireless node, wherein each traffic signal light is responsive to the operational instructions in the control data packets addressed to the distinct Internet protocol address.

2. The system of claim 1, wherein the plurality of wireless nodes comprises wireless local area network nodes, the system further comprising:
a plurality of intersection controllers to control at least one traffic signal light in the plurality of traffic signal lights, wherein each wireless local area network node is communicatively coupled to the traffic signal lights via one of the intersection controllers.

3. The system of claim 2, the system further comprising at least one repeater, wherein the repeater is adapted to transmit signals between at least one wireless local area network node and the master controller.

4. The system of claim 3, wherein the repeater is compliant with the Institute of Electrical and Electronics Engineers 802.16 standards.

5. The system of claim 3, further comprising:
a node controller communicatively coupled to the at least one repeater, wherein the node controller is communicatively coupled to the master controller.

6. The system of claim 2, wherein the wireless local area network nodes are communicatively coupled to each other.

7. The system of claim 2, further comprising:
a node controller communicatively coupled to the plurality of wireless local area network nodes, wherein the node controller is communicatively coupled to the master controller.

8. The system of claim 1, wherein the Internet protocol based communication is provided according to standards set by one of Institute of Electrical and Electronics Engineers 802.11, Institute of Electrical and Electronics Engineers 802.11a, Institute of Electrical and Electronics Engineers 802.11b, Institute of Electrical and Electronics Engineers 802.11g, Institute of Electrical and Electronics Engineers 802.11n, Institute of Electrical and Electronics Engineers 802.11p, Institute of Electrical and Electronics Engineers 802.16, Institute of Electrical and Electronics Engineers 802.16a, Evolution Data Only/Evolution Data Optimized standards, wireless local area network standards, wireless metropolitan area network standards, WiBro standards, Institute of Electrical and Electronics Engineers 802 standards, Orthogonal Frequency Division Multiplexing standards, time-division multiplexing standards, and combinations thereof.

9. The system of claim 1, further comprising:
at least one intersection controller to control at least one traffic signal light in the plurality of traffic signal lights, wherein at least one wireless node is communicatively coupled to the at least one traffic signal light via the at least one intersection controller.

10. The system of claim 9, wherein the wireless nodes are compliant with at least one of Institute of Electrical and Electronics Engineers 802.11 standards, Institute of Electrical and Electronics Engineers 802.16 standards, and Evolution Data Only/Evolution Data Optimized standards.

11. The system of claim 1, wherein the wireless communication link is a bidirectional wireless communication link.

12. The system of claim 11, wherein the bidirectional wireless communication link transmits data upstream from the plurality of wireless nodes to the master controller in data packets including an Internet protocol address, the data comprising one of video data, security data, traffic management data, traffic signal light status data, acknowledgement data, current traffic flow data, emergency vehicle over-ride data, and combinations thereof.

13. The system of claim 1, further comprising:
a memory communicatively coupled to the master controller to store the operational instructions.

14. The system of claim 13, wherein the memory stores a table of the operational instructions correlated to times, dates and distinct Internet protocol addresses, wherein the master controller transmits the operational instructions for each distinct Internet protocol address based on a current date and time.

15. The system of claim 14, wherein the memory is adapted to receive updates to the operational instructions from the master controller, the updates configured to modify the stored operational instructions for one or more of the distinct Internet protocol address, wherein the updates are based on traffic data received at the master controller from at least one of a traffic monitoring network and the plurality of traffic signal lights, wherein the traffic data is associated with the flow of vehicular traffic controlled by at least one of the plurality of traffic signal lights.

16. The system of claim 1, wherein the master controller is adapted to receive traffic data associated with vehicular traffic being controlled by the plurality of traffic signal lights, the master controller further adapted to transmit operational instructions to one or more of the plurality of traffic signal lights based on the received traffic data.

17. The system of claim 1, wherein the master controller is adapted to enable at least one of the plurality of wireless nodes to generate and transmit control data packets to others of the plurality of wireless nodes, and wherein at least one of the wireless nodes is adapted to generate and transmit control data packets to others of the plurality of wireless nodes based on being enabled by the master controller.

18. The system of claim 1, wherein at least one wireless node comprises the master controller, wherein the wireless node comprising the master controller is a controlling wireless node, and wherein the controlling wireless node is communicatively coupled to the master controller to receive control data packets for the traffic signal lights communicatively coupled to the controlling wireless node.

19. A method of controlling a plurality of traffic signal lights, the method comprising:
generating an operational instruction for a selected traffic signal light at a master controller;
determining the Internet protocol address for a wireless node associated with the selected traffic signal light;
generating a data packet for the selected traffic signal light based on the Internet protocol address and the generated operational instruction; and
wirelessly transmitting the data packet from the master controller to the wireless node associated with the selected traffic signal light over an IP-based wireless communication link.

20. The method of claim 19, further comprising:
receiving updated traffic data at the master controller, wherein the traffic data is related to a flow of vehicular traffic controlled by at least one of the plurality of traffic signal lights.

21. The method of claim 20, further comprising:
generating revised operational instructions based on the received updated traffic data; and
storing the revised operational instructions in a memory, the revised operational instructions associated with a time and a date.

22. The method of claim 21, further comprising:
wirelessly transmitting the distinct Internet protocol address and at least a portion of the revised operational instructions in a data packet from the master controller.

23. The method of claim 20, further comprising:
generating revised operational instructions based on the received updated traffic data; and
wirelessly transmitting the distinct Internet protocol address and at least a portion of the revised operational instructions in a data packet from the master controller.

24. The method of claim 20, wherein receiving updated traffic data at the master controller further comprises:
receiving traffic data transmitted from one of the plurality of traffic signal lights wherein the traffic data comprises one of video data, security data, traffic management data, traffic signal light status data, acknowledgement data, current traffic flow data, emergency vehicle over-ride data, and combinations thereof.

25. The method of claim 19, the method further comprising:
generating a control-enabling instruction for at least one control-enabled wireless node at the master controller; and
transmitting the control-enabling instruction to the at least one control-enabled wireless node.

26. The method of claim 25, the method further comprising:
receiving the control enabling instruction at the at least one control-enabled wireless node;
generating a local operational instruction for a selected traffic signal light at the at least one control-enabled wireless node responsive to the control enabling instruction;
determining the Internet protocol address for a wireless node associated with the selected traffic signal light at the at least one control-enabled wireless node;
generating a data packet for the selected traffic signal light based on the Internet protocol address and the generated local operational instruction at the at least one controlling wireless node; and
wirelessly transmitting the data packet from the at least one controlling wireless node to the wireless node associated with the selected traffic signal light over an IP-based wireless communication link.

27. The method of claim 19, wherein wirelessly transmitting the data packet from the master controller to the wireless node comprises regenerating the data packet at a repeater.

28. A method of controlling a plurality of traffic signal lights, the method comprising:
exchanging information among a plurality of wireless nodes, wherein each of the plurality of wireless nodes is associated with a distinct Internet protocol address and at least one of the traffic signal lights; and
sharing control of the traffic signal lights associated with the plurality of wireless nodes among the plurality of wireless nodes based on the exchanged information and based on the Internet protocol addresses.

29. The method of claim 28, wherein sharing control of the traffic signal lights comprises:
generating an operational instruction for a selected traffic signal light based on the exchanged information at a first wireless node;
determining the Internet protocol address for a second wireless node associated with the selected traffic signal light;
generating a data packet for the selected traffic signal light based on the Internet protocol address for the second wireless node and the generated operational instruction; and
wirelessly transmitting the data packet from the first wireless node to the second wireless node associated with the selected traffic signal light over an IP-based wireless communication link.

30. The method of claim 29, wherein the selected traffic signal light is a first selected traffic signal light, wherein the operational instruction is a first operational instruction, and wherein sharing control of the traffic signal lights further comprises:
generating a second operational instruction for a second selected traffic signal light associated with the first wireless node based on the exchanged information at a third wireless node;
determining the Internet protocol address for the first wireless node associated with the second selected traffic signal light;
generating a data packet for the second selected traffic signal light based on the Internet protocol address for the first wireless node and the generated second operational instruction; and
wirelessly transmitting the data packet from the third wireless node to the first wireless node associated with the second selected traffic signal light over an IP-based wireless communication link.

31. The method of claim 30, wherein wirelessly transmitting the data packet from the third wireless node to the first wireless node comprises regenerating the data packet at a repeater.

32. The method of claim 29, wherein wirelessly transmitting the data packet from the first wireless node to the second wireless node comprises regenerating the data packet at a repeater.

33. A system, comprising:
a plurality of wireless nodes dispersed in a geographic area, each wireless node in the plurality of wireless nodes associated with a distinct Internet protocol address; and
a plurality of traffic signal lights dispersed in the geographic area, the traffic signal lights communicatively coupled to the plurality of wireless nodes, wherein a wireless communication link provides Internet protocol based communication among the plurality of wireless nodes, wherein each of the plurality of wireless nodes receives control data packets for the communicatively coupled traffic signal lights from others of the plurality of wireless nodes via the wireless communication link, wherein the control data packets comprise one of the distinct Internet protocol addresses and operational instructions for the at least one traffic signal light communicatively coupled to the wireless node, wherein each traffic signal light is responsive to the operational instructions in the control data packets addressed to the distinct Internet protocol address.

34. The system of claim 33, wherein the plurality of wireless nodes comprises wireless local area network nodes, the system further comprising:
a plurality of intersection controllers to control at least one traffic signal light in the plurality of traffic signal lights, wherein each wireless local area network node is communicatively coupled to the traffic signal lights via one of the intersection controllers.

35. The system of claim 34, the system further comprising at least one repeater, wherein the repeater is adapted to transmit signals between at least two wireless local area network nodes.

36. The system of claim 35, wherein the repeater is compliant with at least one of the Institute of Electrical and Electronics Engineers 802.16 standards and the Institute of Electrical and Electronics Engineers 802.11 standards.

37. The system of claim 33, wherein the Internet protocol based communication is provided according to standards set by one of Institute of Electrical and Electronics Engineers 802.11, Institute of Electrical and Electronics Engineers 802.11a, Institute of Electrical and Electronics Engineers 802.11b, Institute of Electrical and Electronics Engineers 802.11g, Institute of Electrical and Electronics Engineers 802.11n, Institute of Electrical and Electronics Engineers 802.11p, Institute of Electrical and Electronics Engineers 802.16, Institute of Electrical and Electronics Engineers 802.16a, wireless local area network standards, wireless metropolitan area network standards, WiBro standards, Institute of Electrical and Electronics Engineers 802 standards, Evolution Data Only/Evolution Data Optimized standards, Orthogonal Frequency Division Multiplexing standards, time-division multiplexing standards, and combinations thereof.

38. The system of claim 33, wherein at least one of the plurality of wireless nodes comprises a metropolitan area network node, the system further comprising:
at least one intersection controller to control at least one traffic signal light in the plurality of traffic signal lights, wherein the at least one metropolitan area network node is communicatively coupled to the traffic signal lights via one of the intersection controllers.

39. The system of claim 33, wherein the wireless communication link is a bidirectional wireless communication link, wherein the bidirectional wireless communication link transmits data between wireless nodes in the plurality of wireless nodes in data packets, the data comprising one of video data, security data, traffic management data, traffic signal light status data, acknowledgement data, current traffic flow data, emergency vehicle over-ride data, and combinations thereof.

40. The system of claim 33, wherein at least one wireless node comprises a master controller.
